(19) United States
(12) Patent Application Publication
(10) Pub. No.: US 2010/0231620 A1
(43) Pub. Date: Sep. 16, 2010

(54) LIQUID HOLDING CONTAINER

(75) Inventor: Satoshi SHINADA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/722,310

(22) Filed: Mar. 11, 2010

(30) Foreign Application Priority Data
Mar. 16, 2009 (JP) 2009-063102

(51) Int. Cl. B41J 29/38; B41J 2/175

(52) U.S. Cl. 347/6; 347/85

(57) ABSTRACT

A liquid holding container that supplies liquid to a liquid ejecting apparatus, includes: a liquid containing section which contains the liquid; a liquid supply port for supplying the liquid to the liquid ejecting apparatus; and a supply pump which supplies the liquid contained in the liquid containing section to the liquid ejecting apparatus through the liquid supply port.

### BACKGROUND

1. Technical Field

The present invention relates to a liquid holding container and, in particular, to a liquid holding container provided with a built-in supply pump for supplying liquid to the exterior of the liquid holding container.

2. Related Art

As a liquid containing body which is mounted in a liquid ejecting apparatus such as an ink jet printer, for example, an ink cartridge which is mounted in the ink jet printer is used. In the past, an ink supply pump for supplying ink has been provided in the liquid ejecting apparatus, and ink has been supplied from the ink cartridge to the liquid ejecting apparatus by driving the ink supply pump.

In addition, in recent years, the demand for high-precision print quality has increased, and as ink for printing, for example, pigment ink contained in an ink cartridge has been used. Since the particle diameter of a color material in pigment ink is large compared to dye ink, the ink component of the pigment ink sinks on the vertically lower side (bottom portion) of an ink cartridge, and as a result, concentration of ink on the lower side in the ink cartridge is higher, whereas concentration of ink on the upper side is lower, whereby there is a bias in the concentration distribution of the ink in the ink cartridge. In order to solve such a problem, in ink cartridges of the related art, for example, there has been proposed an ink cartridge having an ink flow path configured such that upper ink and lower ink are joined, then, agitated and mixed by the flow of ink (for example, JP-A-2003-80730), or an ink cartridge which has a movable body (an agitation member) being higher in specific gravity than ink therein and makes the ink therein to be agitated by the movement of the agitation member (for example, JP-A-9-309212).

Examples of the above-described related art is disclosed in JP-A-2003-266730, JP-A-2007-331308, JP-A-2007-331342, and JP-A-9-164704.

However, in recent years, the processing speed of a liquid ejecting apparatus has become higher, so that in an ink supply pump provided at the exterior of an ink cartridge, the supply speed of the ink supply pump is slower than the ink discharge speed of a liquid ejecting apparatus. Therefore, a problem occurs in that a sufficient amount of ink cannot be supplied at sufficient speed for the processing efficiency of a liquid ejecting apparatus.

Further, in the related art, a problem also occurs that the agitation of the ink in an ink cartridge cannot be sufficiently performed. For example, in the technology of JP-A-2003-80730, agitation efficiency varies in accordance with the flow rate of ink, so that there is a case where a sufficient agitation effect cannot be obtained. In the technology of JP-A-9-309212, since an agitation member for agitating ink is provided in an ink cartridge, it is necessary to provide a means for moving the agitation member, and also, the volume efficiency of the ink cartridge is lowered by the volume of the agitation member.

### SUMMARY

An advantage of some aspects of the invention is that it provides for the speeding up of liquid supply from a liquid holding container to a liquid ejecting apparatus and for an improvement in agitation efficiency.

The invention can be realized as the following modes and applications.

### Application 1

According to Application 1, there is provided a liquid holding container that supplies liquid to a liquid ejecting apparatus, including: a liquid containing section which contains the liquid; a liquid supply port for supplying the liquid to the liquid ejecting apparatus; and a supply pump which supplies the liquid contained in the liquid containing section to the liquid ejecting apparatus through the liquid supply port.

According to the liquid holding container of Application 1, since the supply pump which supplies liquid is provided in the liquid holding container, liquid supply speed can be increased, so that liquid can be supplied at a speed according to the processing speed of the liquid ejecting apparatus.

### Application 2

The liquid holding container of Application 1 further includes a pressure adjustment section which is provided between the supply pump and the liquid supply port, thereby adjusting the pressure of the liquid. In addition, a term “between the supply pump and the liquid supply port” includes the meaning that refers to any position on a liquid flowing path from the supply pump to the liquid supply port. In general, pressure variation occurs in liquid which is transported by the supply pump. According to the liquid holding container of Application 2, the pressure adjustment section which adjusts pressure of liquid is provided between the supply pump and the liquid supply port. Therefore, by adjusting pressure of liquid, pressure variation of liquid, which is generated by the driving of the supply pump, can be suppressed.

### Application 3

The liquid holding container of Application 2 further includes a connection section which connects the pressure adjustment section and the liquid containing section, thereby returning the liquid from the pressure adjustment section to the liquid containing section. According to the liquid holding container of Application 3, the connection section is provided returning liquid discharged from the liquid containing section again to the liquid containing section. Therefore, the flowing of liquid in the liquid containing section can be generated by the flow of liquid which is discharged from the liquid containing section, and the flow of liquid which is introduced again into the liquid containing section. Accordingly, liquid in the liquid containing section can be made to be uniform without providing a separate member such as a movable body in the liquid containing section.

### Application 4

In the liquid holding container of Application 3, the connection section is provided at a position which induces agitation of liquid in the liquid containing section by liquid returned into the liquid containing section through the connection section. According to the liquid holding container of Application 4, the connection section is provided at a position which induces agitation of liquid in the liquid containing section. Therefore, the agitation of liquid which is contained in the liquid containing section can be promoted by liquid which is returned into the liquid containing section through the connection section.

### Application 5

In the liquid holding container of Application 4, the liquid containing section has an opening portion on the vertically lower side in a state where the liquid holding container is mounted in the liquid ejecting apparatus, and the end on the liquid containing section side of the connection section is connected to the opening portion of the liquid containing section. According to the liquid holding container of Application 5, one end of the connection section is connected to the opening portion provided on the vertically lower side of the liquid containing section. Therefore, liquid is returned from the lower side of the liquid containing section to the interior of the liquid containing section. Accordingly, it is possible to efficiently generate a flow of liquid with high concentration which has sunk on the lower side, so that agitation efficiency of liquid in the liquid containing section can be improved.

### Application 6

In the liquid holding container of Application 4, the liquid containing section has an opening portion, and the end on the liquid containing section side of the connection section is connected to the opening portion, and also, formed so as to face the vertically lower side in a state where the liquid holding container is mounted in the liquid ejecting apparatus. According to the liquid holding container of Application 6, one end of the connection section is connected to the opening portion so as to face the vertically lower side of the liquid containing section. Therefore, it is possible to generate a flow of liquid contained in the liquid containing section so as to move from the upper side to the lower side in the vertical direction. Accordingly, agitation efficiency of liquid in the liquid containing section can be improved.

### Application 7

In the liquid holding container of Application 4, the liquid containing section has an opening portion, and the end on the liquid containing section side of the connection section is connected to the opening portion, and also, is formed so as to face from the vertically lower side to the vertically upper side in a state where the liquid holding container is mounted in the liquid ejecting apparatus. According to the liquid holding container of Application 7, one end of the connection section is connected to the opening portion so as to face from the vertically lower side to the vertically upper side of the liquid containing section. Therefore, it is possible to generate a flow of liquid contained in the liquid containing section so as to move from the lower side to the upper side in the vertical direction. Accordingly, agitation efficiency of liquid in the liquid containing section can be improved.

### Application 8

In the liquid holding container of any of Applications 1 to 7, the supply pump is a piezo pump which is constituted by using a piezoelectric element. According to the liquid holding container of Application 8, by using a piezoelectric element which has been traditionally used, it is possible to constitute a small supply pump in the liquid holding container with simple configuration.

### Application 9

In the liquid holding container of Application 8, the supply pump is constituted so as to function as a sensor which performs the detection of the remaining amount of the liquid by using residual vibration which is generated after the application of voltage to the piezoelectric element. According to the liquid holding container of Application 9, the supply pump can be constituted as to serve two purposes, an ink supply pump and an ink remaining amount detection sensor. Therefore, it is not necessary to separately provide a remaining amount detection sensor, so that cost reduction and reduction in size of the liquid holding container can be achieved.

### Application 10

According to Application 10, there is provided a liquid ejecting apparatus in which the liquid holding container of any of Applications 1 to 9 is mounted, including: a driving section which drives the supply pump. According to the liquid ejecting apparatus of Application 10, the driving of the supply pump provided in the liquid holding container can be controlled from the liquid ejecting apparatus.

### Application 11

In the liquid ejecting apparatus of Application 10, the driving section drives the supply pump for a given time if the electric source of the liquid ejecting apparatus is in an ON state. In general, when the electric source of the liquid ejecting apparatus is in an OFF state, the flowing of liquid is not generated, so that liquid components sink, whereby concentration of liquid on the vertically lower side is higher. According to the liquid ejecting apparatus of Application 11, if the electric source of the liquid ejecting apparatus is an ON state, the supply pump is automatically driven for a given time. Therefore, density unevenness occurring in a print result due to the sinking of thick ink can be suppressed.

### Application 12

The liquid ejecting apparatus of Application 10 further includes a time information acquisition section which acquires time information about an OFF time over which the electric source of the liquid ejecting apparatus remained in an OFF state; and an control section which control the above-mentioned given time on the basis of an OFF time which is represented by the time information, if the electric source of the liquid ejecting apparatus is in an ON state. In general, the extent of sinking of thick ink varies in proportion to an OFF time. According to the liquid ejecting apparatus of Application 12, when the electric source of the liquid ejecting apparatus is in an ON state, the driving time of the supply pump is controlled on the basis of an OFF time over which the electric source of the liquid ejecting apparatus remained in an OFF state. Therefore, the agitation of liquid in the liquid containing section can be appropriately performed in accordance with an OFF time.

### Application 13

The liquid ejecting apparatus of Application 10 further includes an instructions receiving section which receives driving instructions of the supply pump, wherein the driving section drives the supply pump if it receives the driving instructions. According to the liquid ejecting apparatus of Application 13, the supply pump is driven upon the receipt of the driving instructions. Accordingly, the agitation of liquid in the liquid containing section can be performed at a time desired by a user.

### Application 14

In the liquid ejecting apparatus of Application 10, the driving section drives the supply pump also at times other than the time of supply of the liquid to the liquid ejecting apparatus. According to the liquid ejecting apparatus of Application 14, the supply pump is driven also at times other than the time of supply of the liquid to the liquid ejecting apparatus. Therefore, to the pressure adjustment section provided between the liquid containing section and the liquid supply port, liquid with high pressure is supplied compared to a case where the supply pump is not driven. Accordingly, a supply pump can be applied which has lower pumping ability than the necessary pumping ability for the processing speed of the liquid ejecting apparatus.

### Application 15

In the liquid ejecting apparatus of Application 14, the driving section drives the supply pump during an ON state of the electric source of the liquid ejecting apparatus. According to the liquid ejecting apparatus of Application 15, the supply pump is always driven during an ON state of the electric source of the liquid ejecting apparatus. Therefore, compared to a case where the supply pump is not driven, liquid with high pressure can be always supplied to the pressure adjustment section. Further, in the liquid containing chamber having agitation action, agitation is performed during an ON state of the electric source.

### Application 16

In the liquid ejecting apparatus of any of Applications 10 to 14, the driving section changes the driving method of the supply pump at the time of detection of the remaining amount of liquid and at times other than the time of detection of the remaining amount of liquid. According to the liquid ejecting apparatus of Application 16, a driving method of the supply pump is changed at the time of detection of the remaining amount of liquid and at the other case. Therefore, the supply pump can be appropriately driven in accordance with the respective processing.

In the invention, various aspects described above can be applied in appropriate combination or with a portion omitted.

### BRIEF DESCRIPTION OF THE DRAWINGS

The invention will be described with reference to the accompanying drawings, wherein like numbers reference like elements.

FIG. 1 is a perspective view showing the appearance of an ink cartridge as a liquid containing body concerning a first example.

FIG. 2 is a view showing a state where the ink cartridge concerning the first example is mounted in a carriage.

FIG. 3 is a perspective view illustrating the internal configuration of a cartridge main body in the first example.

FIG. 4 is an explanatory view explaining an ink path in the first example and function blocks of an ink jet printer.

FIGS. 5A to 5C are schematic views explaining the configuration of a supply pump in the first example.

FIGS. 6A and 6B are waveform diagrams showing a driving waveform of the supply pump in the first example.

FIGS. 7A and 7B are cross-sectional views illustrating the schematic configuration of a pressure adjustment valve in the first example.

FIGS. 8A and 8B are explanatory views schematically explaining agitation mechanism of ink in an ink containing chamber in the first example.

FIGS. 9A and 9B are explanatory views explaining a control circuit in a second example.

FIG. 10 is a perspective view illustrating the internal configuration of a cartridge main body in Modified Example 1.

FIG. 11 is a perspective view illustrating the internal configuration of a cartridge main body in Modified Example 2.

FIG. 12 is a perspective view illustrating the internal configuration of a cartridge main body of an ink cartridge in Modified Example 3.

### DESCRIPTION OF EXEMPLARY EMBODIMENTS

### A. First Example

### A1. Configuration of Ink Cartridge

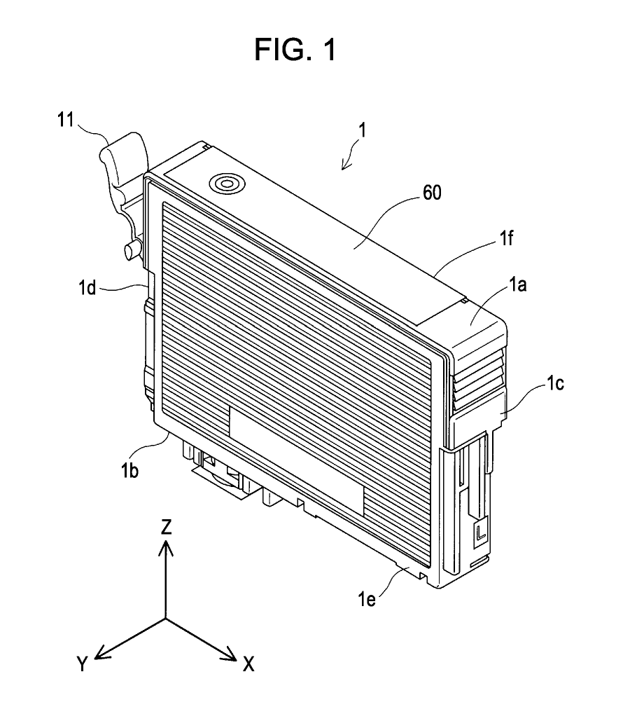

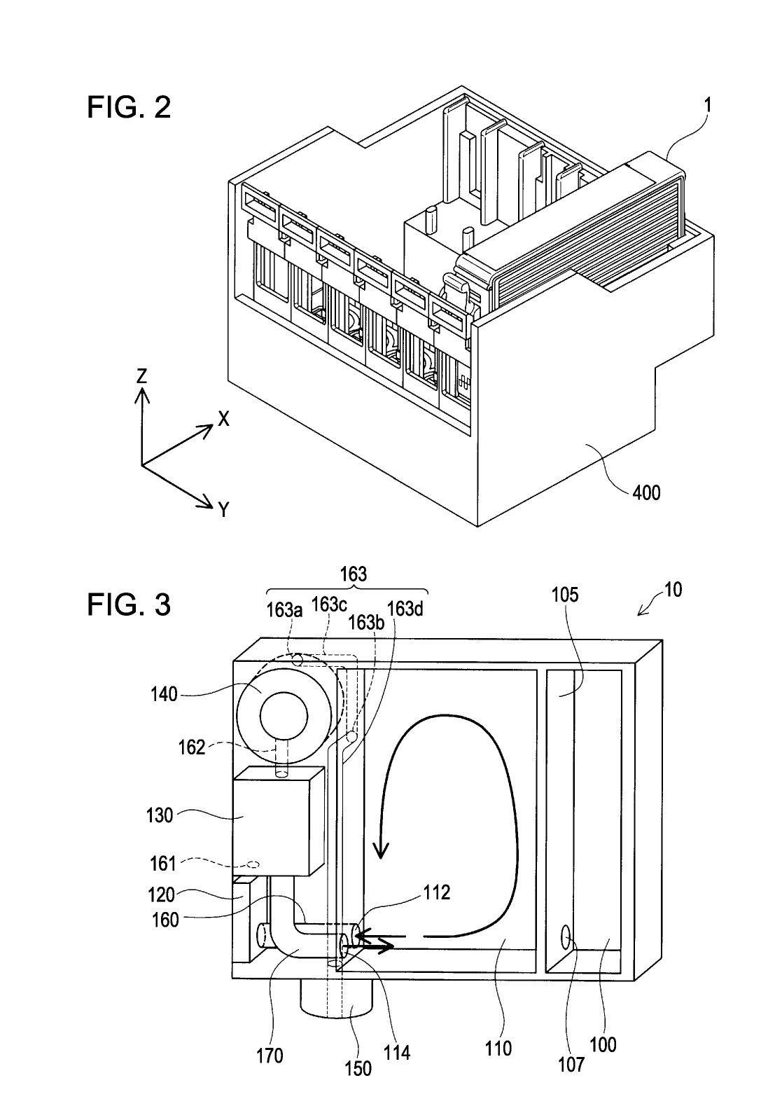

FIG. 1 is a perspective view showing the appearance of an ink cartridge as a liquid holding container concerning a first example. FIG. 2 is a view showing a state where the ink cartridge concerning the first example is mounted in a carriage of a printer as a liquid ejecting apparatus. FIG. 3 is a perspective view illustrating the internal configuration of a cartridge main body in the first example. In addition, in FIGS. 1 and 2, in order to specify the position (direction) of an ink cartridge, XYZ axes are shown. An ink cartridge 1 contains liquid pigment ink in the interior thereof. Hereinafter, in this specification, a “vertical direction” indicates a vertical direction in a state where the ink cartridge 1 is mounted in an ink jet printer, and corresponds to a Z axis.

As shown in FIG. 1, the ink cartridge 1 has an approximately rectangular parallelepiped shape and is constituted by an upper face 1a which is located on the upper side of the vertical direction, a bottom face 1b which is located on the lower side of the vertical direction, and a right face 1c, a left face 1d, a front face 1e, and a back face 1f, which are located between the upper face 1a and the bottom face 1b. The upper face 1a corresponds to a face on the positive direction side of the Z axis; the bottom face 1b, a face on the negative direction side of the Z axis; the right face 1c, a face on the positive direction side of the X axis; the left face 1d, a face on the negative direction side of the X axis; the front face 1e, a face on the positive direction side of the Y axis; and the back face 1f, a face on the negative direction side of the Y axis. In addition, sides on which the respective faces 1a to 1f are located are also called an upper face side, a bottom face side, a right face side, a left face side, a front face side, and a back face side, respectively.

As shown in FIG. 2, the ink cartridge 1 is mounted in a carriage 400 of, for example, an ink jet printer and contains ink to be supplied to the ink jet printer. In addition, in FIG. 2, the ink cartridge 1 is mounted in the carriage 400 (so-called on-carriage). However, it may also be mounted on a mounting portion provided at a separate place from the carriage 400 (so-called off-carriage).

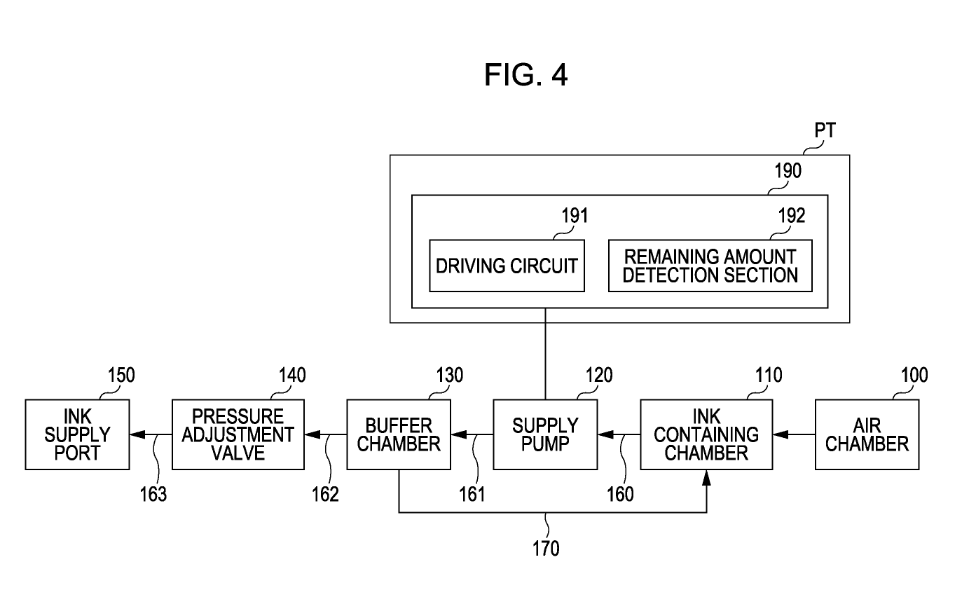

As shown in FIGS. 3 and 4, a cartridge main body 10 is provided with an air chamber 100, an ink containing chamber 110, a supply pump 120, a buffer chamber 130, a pressure adjustment valve 140, an ink supply port 150, communication portions 160 to 163 for flowing ink, and a communication portion 170 which connects the buffer chamber 130 and the ink containing chamber 110 such that they are communicated with each other. On the vertically lower side of a partition plate 105 which divides the air chamber 100 from the ink containing chamber 110, an opening portion 107 is formed which makes the air chamber 100 to be communicated with the ink containing chamber 110. The supply pump 120 and the buffer chamber 130 are communicated with each other by the communication portion 161, the buffer chamber 130 and the pressure adjustment valve 140 are communicated with each other by the communication portion 162, and the pressure adjustment valve 140 and the ink supply port 150 are communicated with each other by the communication portion 163. The communication portion 163 is constituted by communication holes 163a and 163b, a groove 163c, and a communication path 163d. The groove 163c is formed on the back face side of the cartridge main body 10. A film is attached to the back face side of the cartridge main body 10, so that the groove 163c is a hermetically-sealed space, whereby ink can flow from the communication hole 163a to the communication hole 163b. Ink flows from the pressure adjustment valve 140 to the groove 163c through the communication hole 163a, then flows to the communication path 163d through the communication hole 163b, and is supplied to the ink supply port 150. Since each of the communication portions 160, 161, 162, and 163 functions as a flow path for flowing ink, hereinafter, in examples, the communication portions 160, 161, 162, and 163 are called ink flow paths 160, 161, 162, and 163, respectively. In the first example, the ink containing chamber 110 and the supply pump 120 correspond to a “liquid containing section” and a “supply pump” of the appended claims, respectively. In addition, the buffer chamber 130 and the pressure adjustment valve 140 correspond to a “pressure adjustment section” of the claims.

The air chamber 100 is communicated with the atmosphere through an air communication hole (not shown). The ink containing chamber 110 is provided with an ink discharge port 112 which discharges ink to the exterior of the ink containing chamber 110, and an ink introduction port 114 which returns ink into the ink containing chamber 110. The ink discharge port 112 is connected to the supply pump 120 through the ink flow path 160. The ink introduction port 114 is connected to the buffer chamber 130 through the communication portion 170. The ink discharge port 112 in the first example corresponds to an “opening portion” of the claims.

The supply pump 120 is constituted by using a piezoelectric element and supplies ink from the ink containing chamber 110 to the buffer chamber 130 through the ink flow path 160. In the examples, as the piezoelectric element, a piezo element is used. In addition, the supply pump 120 is constituted so as to double as a remaining amount detection sensor which detects the remaining amount of ink in the ink containing chamber 110. The detailed configuration of the supply pump 120 will be described in detail later.

The buffer chamber 130 is connected to the supply pump 120 and the pressure adjustment valve 140 and temporarily stores ink supplied from the supply pump 120. The ink stored in the buffer chamber 130 is supplied to the ink supply port 150 through the pressure adjustment valve 140. In addition, the buffer chamber 130 is connected to the ink containing chamber 110 through the communication portion 170, so that, out of the ink stored in the buffer chamber 130, ink which is not supplied to the pressure adjustment valve 140 is returned to the ink containing chamber 110 through the communication portion 170. In this manner, the communication portion 170 has the function of a bypass which returns ink that does not pass the pressure adjustment valve 140 again to the ink containing chamber 110. Accordingly, hereinafter, in the examples, the communication portion 170 is called a bypass flow path 170. The bypass flow path 170 in the first example corresponds to a “connection section” in the claim.

The pressure adjustment valve 140 is connected to the buffer chamber 130 and the ink supply port 150, thereby adjusting pressure of ink which is supplied from the buffer chamber 130, so as to reduce pressure variation, and then supplying ink to the ink supply port 150. The detailed configuration of the pressure adjustment valve 140 will be described in detail later.

Prior to explanation of the detailed configuration of the cartridge main body 10, an ink path in the first example and function blocks of an ink jet printer PT are explained with reference to FIG. 4. FIG. 4 is an explanatory view explaining an ink path in the first example and function blocks related to the driving of the supply pump 120 in the ink jet printer PT.

As shown in FIG. 4, the ink jet printer PT is provided with a control circuit 190 which controls the supply pump 120 of the ink cartridge 1. If the ink cartridge 1 is mounted in the ink jet printer PT, the control circuit 190 is electrically connected to the ink cartridge 1. The control circuit 190 includes a driving circuit 191 which drives the supply pump 120, and a remaining amount detection section 192 which detects the remaining amount of ink in the ink containing chamber 110 by detecting residual vibration of the piezoelectric element provided at the supply pump 120. The driving circuit 191 intermittently drives the supply pump during an ON state of the electric source of the ink jet printer PT. In addition, the driving circuit 191 temporarily halts the driving of the supply pump 120 at a given timing, and then, applies voltage to the piezoelectric element of the supply pump 120, thereby performing the detection of the remaining amount of ink in the ink containing chamber 110. The driving circuit 191 in the examples corresponds to a “driving section” of the claims.

### A2. Detailed Configuration of Supply Pump

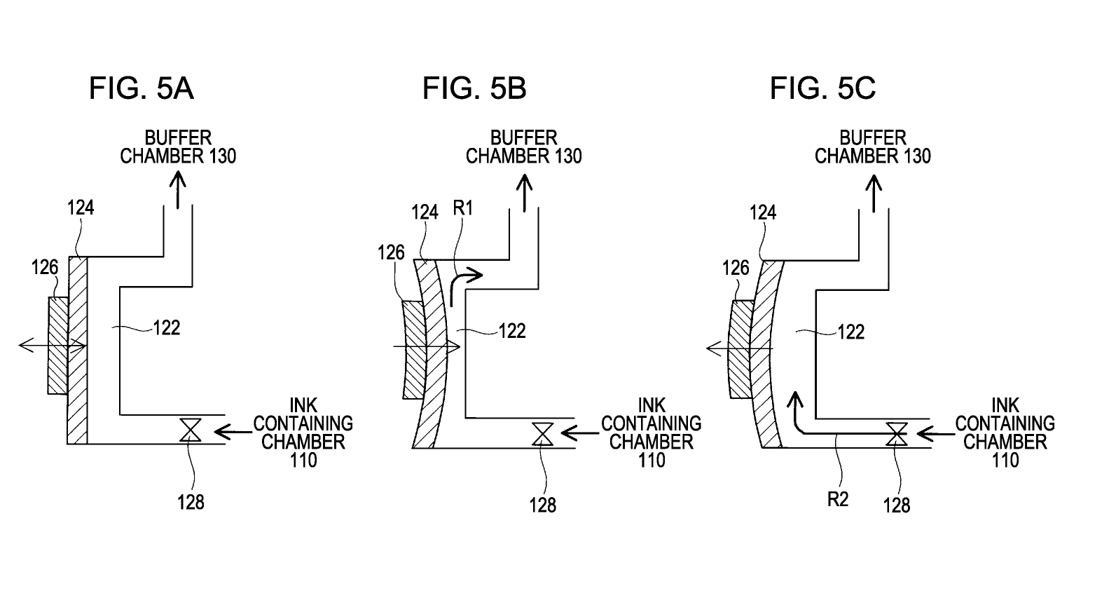

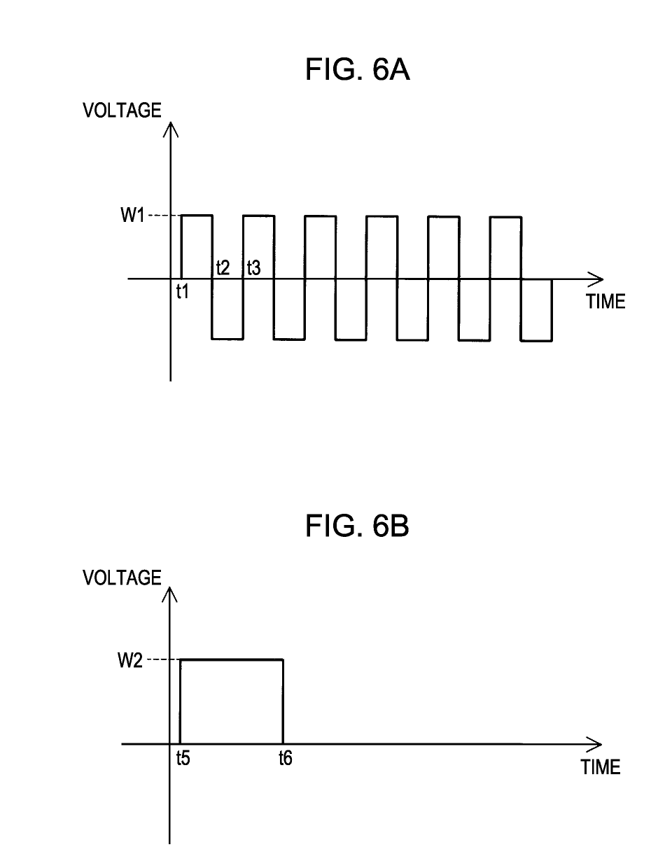

FIGS. 5A to 5C are schematic views explaining the configuration of the supply pump 120 in the first example. FIGS. 6A and 6B are waveform diagrams showing a driving waveform of the supply pump 120 in the first example. FIG. 5A shows a state where the supply pump 120 is not driven, and FIGS. 5B and 5C show states where the supply pump 120 is driven. Further, FIG. 6A shows a waveforms in a case where the supply pump 120 serves as a pump, and FIG. 6B shows a waveforms in a case where the supply pump 120 serves as a remaining amount detection sensor. The supply pump 120 is formed into an approximately U-shape and has a cavity 122 which functions as a portion of the ink flow path, a vibration plate 124 which forms a portion of a wall face of the cavity 122, a piezoelectric element 126 disposed on the vibration plate 124, and a check valve 128 provided on a downstream side (an ink containing chamber 110 side). A terminal of the piezoelectric element 126 is electrically connected to a portion of an electrode terminal of a circuit board of the ink jet printer PT, and when the ink cartridge 1 has been mounted in the ink jet printer PT, the terminal of the piezoelectric element 126 is electrically connected to the ink jet printer PT through the electrode terminal of the circuit board.

If voltage is applied to the piezoelectric element 126, so that the vibration plate 124 is bent inside the cavity 122, as shown in FIG. 5B, pressure in the cavity 122 increases, so that ink flows in the direction indicated by an arrow R1 (a direction facing from a downstream side to an upstream side), thereby being supplied to the buffer chamber 130. Since the check valve 128 is a valve which is opened only in the flowing of ink in the direction of the arrow R1, there are no cases where the ink in the cavity 122 flows backward to the ink containing chamber 110.

Subsequently, if reversed voltage is applied to the piezoelectric element 126, so that the vibration plate 124 is bent outside the cavity 122, as shown in FIG. 5C, pressure in the cavity 122 is negative, so that the check valve 128 is opened, whereby ink is supplied from the ink containing chamber 110 to the cavity 122, as indicated by an arrow R2. In this manner, the supply pump 120 supplies ink from the ink containing chamber 110 to the buffer chamber 130.

As shown in FIG. 6A, in a case where the supply pump 120 functions as a pump which performs the supply of ink, the control circuit 190 intermittently vibrates the piezoelectric element 126 at a certain amplitude W1 (voltage value) and a certain frequency. Between time t1 and time t2, the supply pump 120 is in the state of FIG. 5B, and between time t2 and time t3, the supply pump 120 is in the state of FIG. 5C.

The supply pump 120 also functions as a remaining amount detection sensor which detects the remaining amount of ink in the ink containing chamber 110. As described previously, if voltage is applied from the ink jet printer PT to the piezoelectric element 126 of the supply pump 120, the piezoelectric element 126 is subjected to electrostriction, and then, if voltage application to the piezoelectric element 126 is halted, the vibration plate 124 vibrates and the piezoelectric element 126 generates electromotive force by the electrostriction. By detecting the vibration characteristics (frequency, etc.) of the vibration plate 124 through the electromotive force of the piezoelectric element 126, the remaining amount detection section 192 detects the existence or nonexistence of ink in the cavity 122. Specifically, if the interior state of the cavity 122 changes from an ink-filled state to an air-filled state due to the exhaustion of the ink contained in the cartridge main body 10, the vibration characteristics of the vibration plate 124 varies. By detecting such a change in vibration characteristics, the remaining amount detection section 192 can detect the existence or nonexistence of ink in the cavity 122.

As shown in FIG. 6B, in a case where the supply pump 120 functions as a detection sensor of the remaining amount of ink, a certain amplitude (voltage value) W2 is applied to the piezoelectric element 126 only for a given period of time (between t5 and t6), and then, the application of voltage is halted. After time t6 at which voltage application is halted, the vibration plate 124 generates vibration, and the remaining amount detection section 192 detects the vibration of the vibration plate 124 through the piezoelectric element 126, thereby being able to detect the remaining amount of ink. In this manner, in the first example, the driving circuit 191 drives the piezoelectric element 126 by different driving methods at the time of ink supply and at the time of ink remaining amount detection.

### A3. Detailed Configuration of Pressure Adjustment Valve

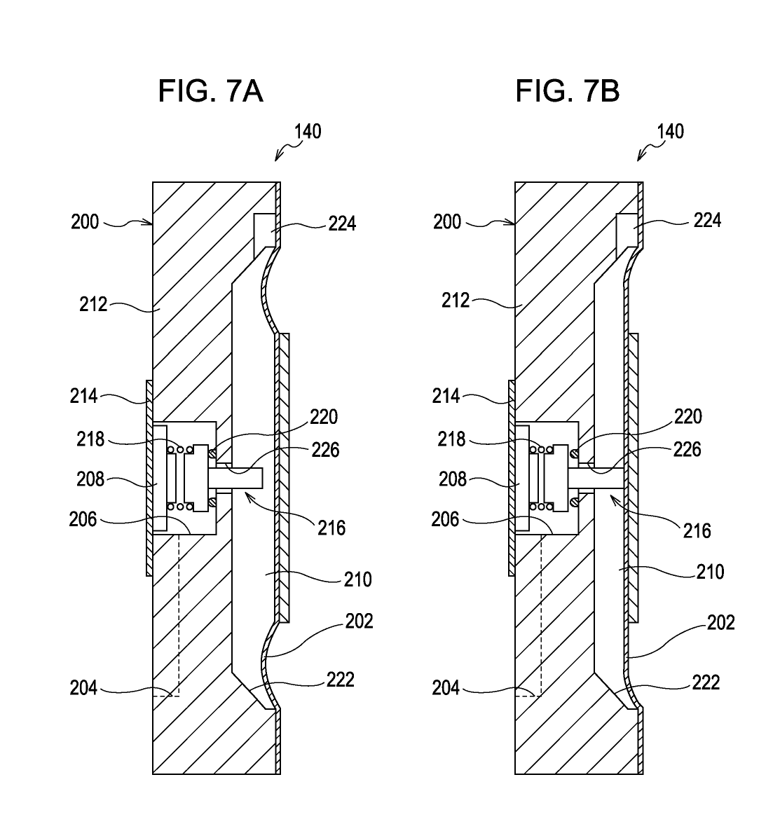

FIGS. 7A and 7B are cross-sectional views illustrating the schematic configuration of the pressure adjustment valve 140 in the first example. FIG. 7A shows the state of the pressure adjustment valve 140 in a case where the ink jet printer PT is in a non-printing state, and FIG. 7B shows the state of the pressure adjustment valve 140 in a case where the ink jet printer PT is in a printing state. The pressure adjustment valve 140 is provided with a unit case 200, a film member 202, an ink introduction path 204, an ink supply chamber 206, a spring bearing seat 208, a pressure chamber 210, a partition wall 212, a film member 214, a movable valve 216, a seal spring 218, a seal member 220, a recessed portion 222, and a pressure chamber outlet 224. The ink introduction path 204 is formed into a groove shape and connected to the ink flow path 162. The ink supplied through the ink introduction path 204 is supplied to the ink supply chamber 206 formed approximately at the center of the unit case 200. In the ink supply chamber 206, the spring bearing seat 208 is inserted into the side face of the unit case 200, and in a state where the spring bearing seat 208 has been inserted, the film member 214 is thermally deposited on the unit case 200 so as to cover the ink supply chamber 206 and the ink introduction path 204. In this way, the ink introduction path 204 and the ink supply chamber 206 are hermetically sealed.

The partition wall 212 is formed so as to divide the ink supply chamber 206 from the pressure chamber 210 and constituted so as to be able to slide the movable valve 216 which constitutes an opening and closing valve. Between the movable valve 216 and the spring bearing seat 208, the seal spring 218 of a coil shape, which serves as a pushing member, is disposed, and by the action of the seal spring 218, the movable valve 216 is pushed with pressing force to the partition wall 212 side, that is, in a direction closing an ink supply hole 226 which connects the ink supply chamber 206 and the pressure chamber 210. To the partition wall 212, the seal member 220 which surrounds the movable valve 216 is attached, and the movable valve 216 is brought into contact with the seal member 220 by a pushing force of the seal spring 218.

The pressure chamber 210 is constituted by the recessed portion 222 formed in the unit case 200, and the film member 202 which covers the recessed portion. The pressure chamber outlet 224 of the pressure chamber 210 is formed on the upper side of a vertical direction and connected to the ink supply port 150 through the ink flow path 163.

In a non-printing state of the ink jet printer PT, that is, in a state where ink is not consumed, load by the seal spring 218 and pressing force of ink which is supplied to the ink supply chamber 206 are applied to the movable valve 216. As a result, as shown in FIG. 7A, the movable valve 216 comes into contact with the seal member 220, thereby becoming a closed-valve state. That is, the pressure adjustment valve 140 is a self-sealing state.

On the other hand, in a printing state of the ink jet printer PT, that is, in a state where ink is consumed, the film member 202 is displaced to the recessed portion 222 side in accordance with the reduction of ink in the pressure chamber 210, so that the central portion of the film member 202 is brought into contact with the movable valve 216. If ink is further consumed, negative pressure is generated in the pressure chamber 210, and in a case where the negative pressure exceeded a given value, the movable valve 216 is pressed by the film member 202. As a result, as shown in FIG. 7B, the movable valve 216 is an opened-valve state. The ink in the ink supply chamber 206 is supplied to the pressure chamber 210 through the ink supply hole 226, so that the negative pressure of the pressure chamber 210 is eliminated. According to this, the movable valve 216 moves so as to be changed again to a closed-valve state shown in FIG. 7A, so that the supply of ink from the ink supply chamber 206 to the pressure chamber 210 is halted. In this manner, the pressure adjustment valve 140 adjusts pressure of ink which is supplied to the ink supply port 150.

### A4. Concerning Agitation of Ink

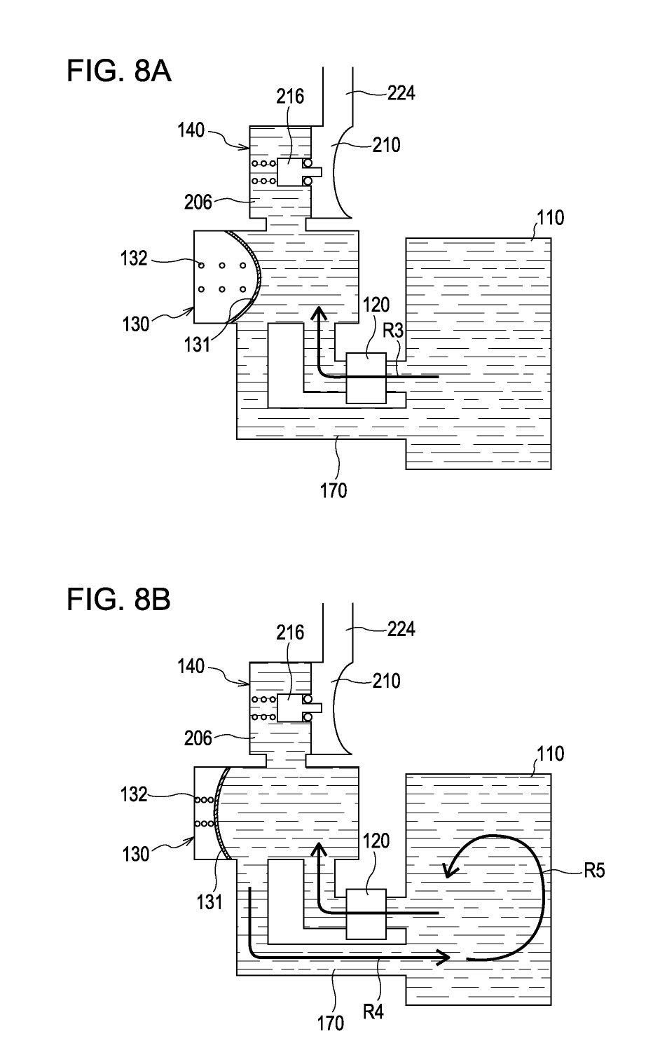

FIGS. 8A and 8B are explanatory views schematically explaining agitation mechanism of ink in the ink containing chamber 110 in the first example. FIG. 8A shows a state where pressure in the buffer chamber 130 is lower than the pushing force of a coil spring 132, and FIG. 8B shows a state where pressure in the buffer chamber 130 is higher than the pushing force of a coil spring 132. The buffer chamber 130 has, in the interior thereof, a flexible membrane-like member 131, and the coil spring 132 as a pushing means which pushes the membrane-like member 131 to the interior side of the buffer chamber 130. In addition, in FIGS. 8A and 8B, a state is shown where the supply of ink to the ink supply port 150 is not performed.

In the state of FIG. 8A, if the supply pump 120 is driven, ink is supplied from the ink containing chamber 110 to the buffer chamber 130, as indicated by an arrow R3, so that pressure in the buffer chamber 130 rises, whereby the membrane-like member 131 is displaced in the opposite direction to the pushing force of the coil spring 132, and thus, the volume of the buffer chamber 130 is expanded, thereby becoming the state of FIG. 8B.

In the state of FIG. 8B, the volume of the buffer chamber 130 is at its largest, and further expansion cannot occur. Further, since the supply of ink to the ink supply port 150 is also not performed, ink does not flow also to the pressure adjustment valve 140. In this state, if the supply pump 120 is driven, so that the further supply of ink from the ink containing chamber 110 to the buffer chamber 130 is performed, the ink in the buffer chamber 130 is returned to the ink containing chamber 110 through the bypass flow path 170, as indicated by an arrow R4. As a result, as indicated by an arrow R5, in the ink containing chamber 110, the flow of ink which is discharged from the ink containing chamber 110, and the flow of ink which is returned to the ink containing chamber 110 are generated, so that the ink in the ink containing chamber 110 is agitated.

According to the ink cartridge 1 of the first example described above, since the supply pump 120 which supplies ink is provided in the cartridge main body 10, ink supply speed can be increased, so that ink can be supplied at speed according to the processing speed of the ink jet printer PT.

Further, according to the ink cartridge 1 of the first example, as a connection section for returning the ink discharged from the ink containing chamber 110 again to the ink containing chamber 110, the bypass flow path 170 is provided. Therefore, by the flow of ink which is discharged from the ink containing chamber 110 and the flow of ink which is introduced again to the ink containing chamber 110, the flowing of ink in the ink containing chamber 110 can be generated. Accordingly, it is possible to make the ink in the ink containing chamber uniform without providing a separate member such as a movable body (agitation member) in the ink containing chamber 110. If the agitation member is provided, the volume of ink which can be contained in the ink containing chamber 110 is reduced at least by the volume of the movable body. However, according to the ink cartridge 1 of this example, since the agitation member is not needed, the volume efficiency of the ink containing chamber 110 can be improved. Further, in the case of using the agitation member, collision noise of the movable body with the wall face of the ink containing chamber 110 is generated. However, according to the ink cartridge 1 of this example, since the agitation member is not needed, it is possible to make operation sound to be quiet without the generation of collision noise.

In addition, according to the ink cartridge 1 of the first example, the bypass flow path 170 is provided so as to agitate the ink in the ink containing chamber 110. Specifically, one end of the bypass flow path 170 is connected to an opening portion which is the ink introduction port 114 provided on the vertically lower side of the ink containing chamber 110. Therefore, ink is returned from the lower side of the ink containing chamber 110 to the interior of the ink containing chamber 110. Accordingly, it is possible to efficiently generate a flow of the ink which exists on the vertically lower side and has increased in concentration due to the sinking of ink component to the lower side of the ink containing chamber 110, so that the agitation efficiency of the ink in the ink containing chamber 110 can be improved.

In general, pressure variation occurs in ink which is transported by the supply pump 120. According to the ink cartridge 1 of the first example, the pressure adjustment valve 140 as a pressure adjustment section which adjusts pressure of ink is provided between the supply pump 120 and the ink supply port 150. Therefore, pressure of ink is adjusted, so that pressure variation of ink which occurs due to the driving of the supply pump can be suppressed.

According to the ink cartridge 1 of the first example, the supply pump 120 is driven at times other than the time of supply of ink to the ink jet printer PT. Specifically, the supply pump is always driven during an ON state of the electric source of the ink jet printer PT. Therefore, in the buffer chamber 130 provided between the ink containing chamber 110 and the ink supply port 150, ink which has a high pressure is stored compared to a case where the supply pump 120 is not driven. Therefore, a supply pump can be applied which has lower pumping ability than the necessary pumping ability for the processing speed of the ink jet printer PT. In other words, it is not necessary to use a pump having pumping ability which generates the necessary largest ink flow rate for the processing speed of the ink jet printer PT, and the supply pump 120 which has a lower pumping ability can be used. In order to generate high pressure in the piezoelectric element 126 of the supply pump 120, it is necessary to apply high voltage, so that it causes damage or a lowering in durability of the piezoelectric element 126. However, by using the supply pump 120 which has low pumping ability, breakdown of the supply pump 120 can be suppressed. In addition, according to the ink cartridge 1 of the first example, by using the supply pump 120 which has low pumping ability, it can be suppressed that the withstanding pressure of the buffer chamber 130, the withstanding pressure of the bypass flow path 170, and the withstanding pressure of self-sealing ability of the pressure adjustment valve 140 is lower than pressing force of the supply pump 120, and consequently, in addition to the fact that the damage to each structure can be suppressed, there are advantages that more inexpensive material can be used, a system can be realized with more simple structure, and so on.

In addition, according to the ink cartridge 1 of the first example, since the supply pump 120 is constituted by using a piezoelectric element which has been traditionally used, it is possible to constitute a small supply pump in the ink cartridge 1 with simple configuration. In addition, since the supply pump 120 is constituted so as to serve two purposes of an ink supply pump and an ink remaining amount detection sensor, it is not necessary to separately provide a remaining amount detection sensor, so that cost reduction and reduction in size of the ink cartridge 1 can be achieved. In addition, in the ink cartridge 1, since the driving method of the supply pump 120 is changed at the time of detection of the remaining amount of ink and at a time (time of ink supply time and ink agitation) other than the time of detection of the remaining amount of ink, the supply pump can be appropriately driven in accordance with the respective processing.

### B. Second Example

In a second example, in accordance with a time over which the electric source of the ink jet printer PT remained in an OFF state, the supply pump 120 is driven, thereby agitating the ink in the ink containing chamber 110. In the second example, the ink cartridge 1 has the same configuration as that of the first example. In the second example, the supply pump 120 is not driven at all times, but the driving of the supply pump 120 is performed at the time of printing in the ink jet printer PT, a time when the electric source of the ink jet printer is in an ON state, and a time when ink agitation instructions are given by a user through the ink jet printer.

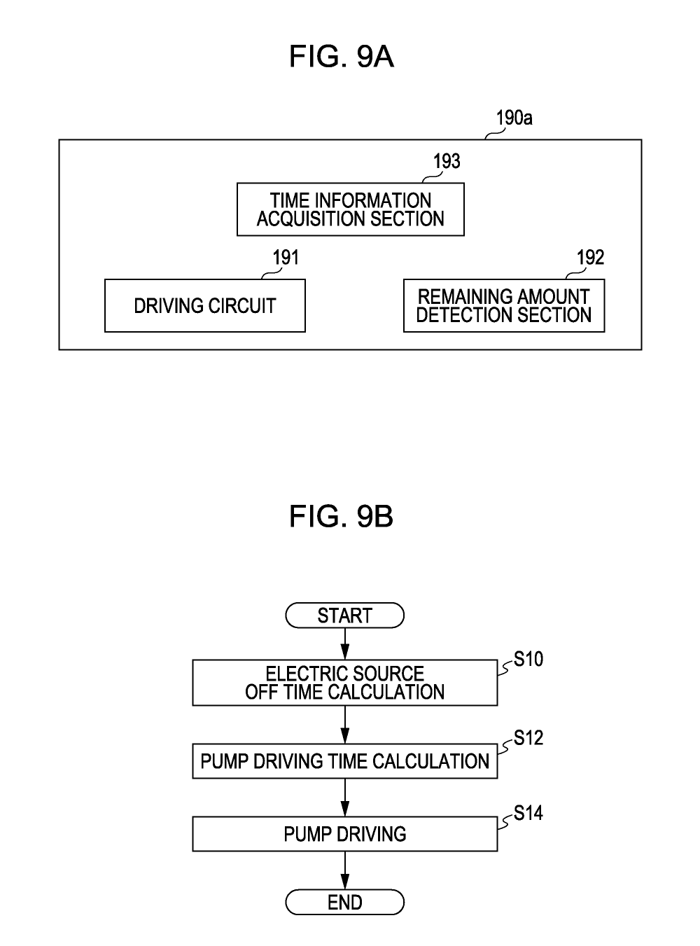

FIGS. 9A and 9B are explanatory views explaining a control circuit 190a of the ink jet printer in the second example. FIG. 9A shows function blocks of the control circuit 190a, and FIG. 9B is a flow chart explaining the processing when the electric source of the ink jet printer is turned on, which is executed by the control circuit 190a. As shown in FIG. 9A, the control circuit 190a includes the driving circuit 191, the remaining amount detection section 192, and a time information acquisition section 193. The driving circuit 191 and the remaining amount detection section 192 have the same configurations as those of the first example. The time information acquisition section 193 in the second example corresponds to a time information acquisition section of the claims. As shown in FIG. 9B, the time information acquisition section 193 detects that the electric source of the ink jet printer is in an ON state, thereby acquiring time information about an elapsed time over which the electric source of the ink jet printer remained in an OFF state (Step S10). Subsequently, the time information acquisition section 193 calculates the driving time of the supply pump 120 in accordance with the time over which the electric source remained in an OFF state (Step S12). In accordance with the driving time calculated by the time information acquisition section 193, the driving circuit 191 drives the supply pump 120, thereby performing ink agitation (Step S14). As a method of calculating the time over which the electric source remained in an OFF state, for example, in a case where the ink cartridge is provided with a read-writable memory element which stores information about the ink cartridge, the processing of storing a time over which the electric source was turned off in the memory element is performed in the processing at a time when the electric source is turned off, and then, at a time when the electric source is turned on, a time when the electric source remained turned off can be calculated from the difference between the current time and the time when the electric source was turned off, which is read out from the memory element. According to this method, even in a case where a certain ink cartridge has been transferred to a different ink jet printer, it is possible to calculate easily and accurately an electric source OFF time.

The driving circuit 191 drives the supply pump 120 also at the time of ink supply (at the time of printing processing by the ink jet printer) and at the time of the inputting of instructions by a user. In addition, the inputting of instructions by a user may also be constituted such that, for example, if instructions for the agitation of the ink of the ink cartridge 1 are given by a user to the ink jet printer, the driving circuit 191 of the ink jet printer drives the supply pump 120 for a predetermined time in order to agitate ink. In addition, the driving circuit 191 has the functions of an “adjustment section” and an “instructions receiving section” in the claims.

In general, since the flowing of ink does not occurs during an OFF state of the electric source of the ink jet printer, concentration of ink which has sunk on the vertically lower side is thickened. According to the ink cartridge of the second example, if the electric source of the ink jet printer is in an ON state, the supply pump 120 is automatically driven for a given time. Specifically, when the electric source of the ink jet printer is in an ON state, the driving time of the supply pump 120 is controlled on the basis of an OFF time representing an elapsed time over which the electric source of the ink jet printer remained in OFF state. Therefore, time adjustment such as the increase or the reduction of agitation time of the ink in the ink containing chamber 110 can be appropriately performed in accordance with an OFF time, so density unevenness occurring in a print result can be suppressed.

In addition, according to the ink cartridge 1 of the second example, the supply pump 120 is driven in accordance with driving instructions from a user. Therefore, agitation of liquid in the ink cartridge 1 can be performed at a time desired by a user.

### C. Modified Examples

(1) In the first example, the bypass flow path 170 is constituted such that one end of the bypass flow path 170 which is connected to the ink introduction port 114 is approximately parallel to the bottom face of the cartridge main body 10, in other words, ink is returned in a direction approximately parallel to the longitudinal direction of the bottom face of the cartridge main body 10. However, for example, a configuration may also be made such that one end of the bypass flow path 170 which is connected to the ink introduction port 114 faces the bottom face 11 which is located on the vertically lower side.

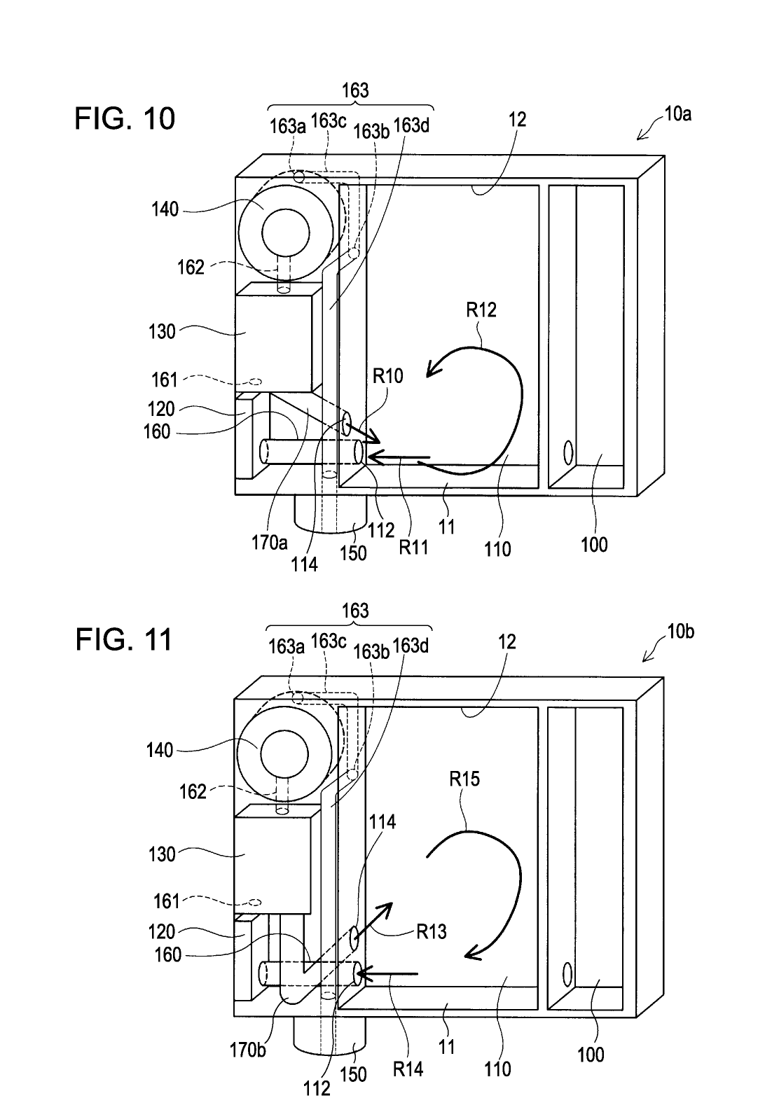

FIG. 10 is a perspective view illustrating the internal configuration of a cartridge main body 10a in Modified Example 1. The cartridge main body 10a has the same configuration as the cartridge main body 10 of the first example except for the position of the ink introduction port 114 and the shape of a bypass flow path 170a. In the cartridge main body 10a, the ink introduction port 114 is formed on the vertically upper side than the ink discharge port 112. The bypass flow path 170a is formed such that one end thereof which is connected to the ink introduction port 114 extends in a direction (arrow R10) facing the vertically lower side of the cartridge main body 10a, that is, the bottom face 11. By such a configuration, ink returned from the bypass flow path 170a into the ink containing chamber 110 flows toward the bottom face 11, and at the same time, flows so as to be discharged from the ink discharge port 112 by the supply pump 120, as indicated by an arrow R11. Therefore, according to the cartridge main body 10a of Modified Example 1, it is possible to generate a flow of ink in the ink containing chamber 110, thereby agitating the ink in the ink containing chamber 110, as indicated by an arrow R12.

(2) In addition, one end of the bypass flow path 170 which is connected to the ink introduction port 114 may also be formed in a direction facing from the vertically lower side to the vertically upper side. FIG. 11 is a perspective view illustrating the internal configuration of a cartridge main body 10b in Modified Example 2. The cartridge main body 10b has the same configuration as the cartridge main body 10 of the first example except for the position of the ink introduction port 114 and the shape of a bypass flow path 170b. In the cartridge main body 10b, the ink introduction port 114 is formed on the vertically upper side than the ink discharge port 112. The bypass flow path 170b is formed such that one end thereof which is connected to the ink introduction port 114 extends in a direction facing from the vertically lower side to the vertically upper side of the cartridge main body 10b, that is, in a direction (arrow R13) facing from the vicinity of the bottom face 11 to the upper face 12. By such a configuration, ink returned from the bypass flow path 170b into the ink containing chamber 110 flows from the vicinity of the bottom face 11 toward the upper face 12, and at the same time, flows so as to be discharged from the ink discharge port 112 by the supply pump 120, as indicated by an arrow R14. Therefore, according to the cartridge main body 10b of Modified Example 2, it is possible to generate a flow of ink in the ink containing chamber 110, thereby agitating the ink in the ink containing chamber 110, as indicated by an arrow R15.

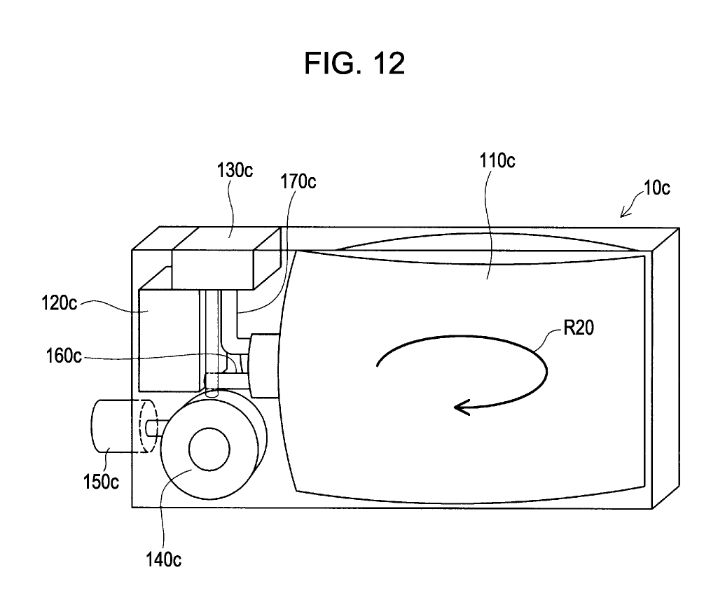

(3) In the first example, an on-carriage type ink cartridge 1 has been used and explained as an example. However, for example, an off-carriage type ink cartridge is also applicable. FIG. 12 is a perspective view illustrating the internal configuration of a cartridge main body 10c of an ink cartridge in Modified Example 3. The cartridge main body 10c is provided with an ink pack 110c, a supply pump 120c, a buffer chamber 130c, a pressure adjustment valve 140c, an ink supply port 150c, an ink flow path 160c which connects the ink pack 110c and the supply pump 120c, and a bypass flow path 170c which connects the buffer chamber 130c and the ink pack 110c such they are communicated with each other. The ink pack 110c can adopt any of various known configurations. In addition, the buffer chamber 130c and the pressure adjustment valve 140c are communicated with each other by an ink flow path, and the pressure adjustment valve 140c and the ink supply port 150c are communicated with each other by an ink flow path.

Ink supplied from the ink pack 110c to the buffer chamber 130c by the supply pump 120c without passing the pressure adjustment valve 140c is returned into the ink pack 110c through the bypass flow path 170c. In this time, in the ink containing chamber 110, the flow of ink which is discharged from the ink pack 110c through the ink flow path 160c and the flow of ink which is returned to the ink pack 110c through the bypass flow path 170c are generated. As a result, as indicated by an arrow R20 in FIG. 12, the flow of ink is generated in the ink pack 110c. Therefore, according to the cartridge main body 10c of Modified Example 3, the flow of ink is generated in the ink pack 110c, so that the ink can be agitated.

(4) In each example described above, one end of the bypass flow path 170 which is connected to the ink containing chamber 110 is provided so as to agitate the liquid in the ink containing chamber 110. However, for example, in a case where ink is of a composition which hardly sinks, any portion, for example, one end of the bypass flow path 170 may also be connected to the vicinity of the upper face 12 of the ink containing chamber 110. According to Modified Example 4, the bypass flow path 170 can be freely arranged.

In the ink cartridges of each example and each modified example, which are described above, the configuration of the ink flow path is not limited to those described in the examples, but various known flow path configurations can be applied.

Although various examples of the invention have been explained above, the invention is not limited to these examples, but various configurations can be taken within a scope that does not depart from the purpose of the invention.

What is claimed is:

1. A liquid holding container that supplies liquid to a liquid ejecting apparatus, comprising:
a liquid containing section which contains the liquid;
a liquid supply port for supplying the liquid to the liquid ejecting apparatus; and
a supply pump which supplies the liquid contained in the liquid containing section to the liquid ejecting apparatus through the liquid supply port.

2. The liquid holding container according to claim 1, further comprising:
a pressure adjustment section which is provided between the supply pump and the liquid supply port, thereby adjusting pressure of the liquid.

3. The liquid holding container according to claim 2, further comprising:
a connection section which connects the pressure adjustment section and the liquid containing section, thereby returning the liquid from the pressure adjustment section to the liquid containing section.

4. The liquid holding container according to claim 3, wherein the connection section is provided at a position which induces agitation of liquid in the liquid containing section by liquid returned into the liquid containing section through the connection section.

5. The liquid holding container according to claim 4, wherein the liquid containing section has an opening portion on the vertically lower side in a state where the liquid holding container is mounted in the liquid ejecting apparatus, and
the end on the liquid containing section side of the connection section is connected to the opening portion of the liquid containing section.

6. The liquid holding container according to claim 4, wherein the liquid containing section has an opening portion, and
the end on the liquid containing section side of the connection section is connected to the opening portion, and also, is formed so as to extend toward the vertically lower side in a state where the liquid holding container is mounted in the liquid ejecting apparatus.

7. The liquid holding container according to claim 4, wherein the liquid containing section has an opening portion, and
the end on the liquid containing section side of the connection section is connected to the opening portion, and also, formed so as to extend from the vertically lower side to the vertically upper side in a state where the liquid holding container is mounted in the liquid ejecting apparatus.

8. The liquid holding container according to claim 1, wherein the supply pump is a piezo pump which is constituted by using a piezoelectric element.

9. The liquid holding container according to claim 8, wherein the supply pump is constituted so as to function as a sensor which performs the detection of the remaining amount of the liquid by using vibration which is generated after the application of voltage to the piezoelectric element.

10. A liquid ejecting apparatus in which the liquid holding container according to claim 1 is mounted, comprising:
a driving section which drives the supply pump.

11. The liquid ejecting apparatus according to claim 10, wherein the driving section drives the supply pump for a predetermined time if the electric source of the liquid ejecting apparatus is in an ON state.

12. The liquid ejecting apparatus according to claim 11, further comprising:
a time information acquisition section which acquires time information about an OFF time over which the electric source of the liquid ejecting apparatus remained in an OFF state; and
an adjustment section which adjusts the predetermined time on the basis of an OFF time of the electric source of the liquid ejecting apparatus, which is represented by the time information.

13. The liquid ejecting apparatus according to claim 10, further comprising:
an instructions receiving section which receives driving instructions of the supply pump,
wherein the driving section drives the supply pump if it receives the driving instructions.

14. The liquid ejecting apparatus according to claim 10, wherein the driving section drives the supply pump also at times other than the time of ejection of the liquid by the liquid ejecting apparatus.

15. The liquid ejecting apparatus according to claim 14, wherein the driving section drives the supply pump during an ON state of the electric source of the liquid ejecting apparatus.

16. The liquid ejecting apparatus according to claim 10, wherein the driving section changes over a driving method of the supply pump at the time of detection of the remaining amount of the liquid and at times other than the time of detection of the remaining amount of the liquid.

17. A liquid supply system provided with a plurality of liquid holding containers which supply liquid to a liquid ejecting apparatus,
wherein each of the liquid holding containers includes
a liquid containing section which contains the liquid;
a liquid supply port for supplying the liquid to the liquid ejecting apparatus; and
a supply pump for supplying the liquid contained in the liquid containing section to the exterior through the liquid supply port,
the system comprising a driving section which drives each of the supply pumps of the plurality of liquid holding containers.
